(19) United States
(12) Patent Application Publication
(10) Pub. No.: US 2026/0348182 A1
(43) Pub. Date: Nov. 5, 2026

(54) SWIMMING POOL CLEANING ROBOT WATER OUTLET DETECTION METHOD, SYSTEM, AND MEDIUM.

(71) Applicant: Seauto (Guangdong Hengqin) Technology Co., Ltd., Zhuhai City (CN)

(72) Inventor: Zhuoming Deng, Zhuhai City (CN)

(21) Appl. No.: 19/678,829

(22) Filed: May 15, 2026

Related U.S. Application Data
(63) Continuation of application No. PCT/CN2024/094113, filed on May 20, 2024.

(30) Foreign Application Priority Data
Apr. 17, 2024 (CN) 202410459499.6

(51) Int. Cl. E04H 4/16; B25J 9/16; B25J 11/00; B25J 13/08

(52) U.S. Cl. CPC E04H 4/1654; B25J 9/1679; B25J 11/0085; B25J 13/088

(57) ABSTRACT

A swimming pool cleaning robot water outlet detection method, system, and medium, the method including: controlling the swimming pool cleaning robot to stop operating for a first preset time and recording an attitude angle θ1 of the swimming pool cleaning robot at this moment in response to a first water outlet detection probe being out of water; acquiring a conducting state of a second water outlet detection probe; controlling the swimming pool cleaning robot to continue operating in response to the second water outlet detection probe being in the conducting state; controlling the swimming pool cleaning robot to continue to stop operating for a second preset time and recording an attitude angle θ2 of the swimming pool cleaning robot at this moment in response to the second water outlet detection probe being not in the conducting state; comparing the attitude angle θ2 with the attitude angle θ1.

### CROSS REFERENCE TO RELATED APPLICATIONS

The present application is a Continuation Application of PCT Application No. PCT/CN2024/094113 filed on May 20, 2024, which claims priority of Chinese Patent Application No. 2024104594996 filed on Apr. 17, 2024, before CNIPA. All the above are hereby incorporated by reference in their entirety as part of the present disclosure.

### TECHNICAL FIELD

The present disclosure relates to the technical field of robots, and particularly relates to a swimming pool cleaning robot water outlet detection method, system, and medium.

### BACKGROUND

The swimming pool cleaning robot is a household-level consumer robot, which is configured to clean a swimming pool, with functions similar to a sweeping robot, and the difference from the sweeping robot is that the application scenario of the swimming pool cleaning robot is underwater, and the swimming pool cleaning robot needs to work in a swimming pool. A persistent pain point for swimming pool cleaning is that manually cleaning is cumbersome and time-consuming. The industry generally begins to use machines to perform swimming pool cleaning work, and many companies are researching path-related algorithms, causing a machine to clean a swimming pool according to a set route, leading to higher cleaning efficiency.

Current swimming pool cleaning robots have phenomena such as false positives, missed detections, or insensitivity regarding the water outlet detection method. For example, the machine is still in an operation state after the robot is out of water, or the machine accidentally stops working after accidentally driving away from a water area.

### SUMMARY

A main object of the present disclosure is to propose a swimming pool cleaning robot water outlet detection method, aiming to accurately determine a water outlet state of a swimming pool cleaning robot, analyze whether the cause of water outlet is manual removal or accidental driving away from a water area, and reduce a misjudgment rate.

To achieve the above purposes, the present disclosure provides a swimming pool cleaning robot water outlet detection method, where a top of the swimming pool cleaning robot is provided with a first water outlet detection probe, a bottom of the swimming pool cleaning robot is provided with a second water outlet detection probe, an interior of the swimming pool cleaning robot is provided with a gyroscope sensor configured to detect a triaxial attitude angle of the swimming pool cleaning robot, and the swimming pool cleaning robot water outlet detection method includes the following steps:
step S10, controlling the swimming pool cleaning robot to stop operation for a first preset time, and recording an attitude angle θ1 of the swimming pool cleaning robot at this moment, in response to the first water outlet detection probe being out of water;
step S20, acquiring a state of the second water outlet detection probe;
step S30, controlling the swimming pool cleaning robot to continue operation in response to the second water outlet detection probe being in a conducting state;
step S40, controlling the swimming pool cleaning robot to maintain stopped operation for a second preset time, and recording an attitude angle θ2 of the swimming pool cleaning robot at this moment, in response to the second water outlet detection probe being not in the conducting state;
step S401, comparing the attitude angle θ2 with the attitude angle θ1;
step S402, determining, based on a size of a change of the attitude angle θ2 relative to the attitude angle θ1, an operation state of the swimming pool cleaning robot;
step S403, controlling, based on the operation state, the swimming pool cleaning robot to continue operation or stop operation.

In some implementations, the determining, based on the size of the change of the attitude angle θ2 relative to the attitude angle θ1, the operation state of the swimming pool cleaning robot includes:
step S4021, determining that the operation state of the swimming pool cleaning robot is an accidental stop operation in response to the change of the attitude angle θ2relative to the attitude angle θ1 being greater than a preset threshold;
step S4022, determining that the operation state of the swimming pool cleaning robot is an accidental driving away from a water surface in response to the change of the attitude angle θ2 relative to the attitude angle θ1 being less than or equal to the preset threshold.

In some implementations, the method further includes, subsequent to the step S30:
step S301, controlling the swimming pool cleaning robot to execute a retreat program to retreat into water for subsequent work.

In some implementations, the step S403 includes:
step S4031, controlling the swimming pool cleaning robot to maintain the stop operation state in response to the operation state of the swimming pool cleaning robot being the accidental stop operation.

In some implementations, the step S403 includes:
step S4032, controlling the swimming pool cleaning robot to execute the retreat program to return to water for subsequent work in response to the operation state of the swimming pool cleaning robot being the accidental driving away from the water surface.

To achieve the above purposes, the present disclosure further proposes a swimming pool cleaning robot water outlet detection system, where the system includes a first water outlet detection probe provided at a top of a swimming pool cleaning robot, a second water outlet detection probe provided at a bottom of the swimming pool cleaning robot, and a gyroscope sensor provided in an interior of the swimming pool cleaning robot. The system further includes a memory, a processor, and a swimming pool cleaning robot water outlet detection program stored on the processor, the swimming pool cleaning robot water outlet detection program, when executed by the processor, performs the following steps:
controlling the swimming pool cleaning robot to stop operation for a first preset time, and recording an attitude angle θ1 of the swimming pool cleaning robot at this moment, in response to the first water outlet detection probe being out of water;
acquiring a conducting state of the second water outlet detection probe;
controlling the swimming pool cleaning robot to continue operation in response to the second water outlet detection probe being in a conducting state;
controlling the swimming pool cleaning robot to maintain stopped operation for a second preset time, and recording an attitude angle θ2 of the swimming pool cleaning robot at this moment, in response to the second water outlet detection probe being not in the conducting state;
comparing the attitude angle θ2 with the attitude angle θ1;
determining, based on a size of a change of the attitude angle θ2 relative to the attitude angle θ1, an operation state of the swimming pool cleaning robot;
controlling, based on the operation state, the swimming pool cleaning robot to continue operation or stop operation.

In some implementations, the swimming pool cleaning robot water outlet detection program, when executed by the processor, further performs the following steps:
determining that the operation state of the swimming pool cleaning robot is an accidental stop operation in response to the change of the attitude angle θ2 relative to the attitude angle θ1 being greater than a preset threshold;
determining that the operation state of the swimming pool cleaning robot is an accidental driving away from a water surface in response to the change of the attitude angle θ2 relative to the attitude angle θ1 being less than or equal to the preset threshold.

In some implementations, the method further includes, subsequent to the step of controlling the swimming pool cleaning robot to continue operation in response to the second water outlet detection probe being in the conducting state:
controlling the swimming pool cleaning robot to execute a retreat program to retreat into water for subsequent work.

In some implementations, the step of controlling, based on the operation state, the swimming pool cleaning robot to continue operation or stop operation further includes:
controlling the swimming pool cleaning robot to maintain the stop operation state in response to the operation state of the swimming pool cleaning robot is the accidental stop operation.

To achieve the above purposes, the present disclosure further proposes a non-transitory computer-readable storage medium, where the non-transitory computer-readable storage medium stores a swimming pool cleaning robot water outlet detection program, the swimming pool cleaning robot water outlet detection program performs the steps of the method as described above in response to being called by a processor.

The beneficial effects of the swimming pool cleaning robot water outlet detection method, system, and medium of the present disclosure are:

With the above technical solution, the present disclosure leads to controlling a swimming pool cleaning robot to stop operation for a first preset time, and recording an attitude angle θ1 of the swimming pool cleaning robot at this moment, in response to a first water outlet detection probe being out of water; acquiring a conducting state of the second water outlet detection probe; controlling the swimming pool cleaning robot to continue operation in response to the second water outlet detection probe being in a conducting state; controlling the swimming pool cleaning robot to remain stopped for a second preset time, and recording an attitude angle θ2 of the swimming pool cleaning robot at this moment; comparing the attitude angle θ2 with the attitude angle θ1, determining an operating state of the swimming pool cleaning robot based on a size of a change of the attitude angle θ2 relative to the attitude angle θ1, controlling the swimming pool cleaning robot to continue operation or stop operation based on the operating state, accurately determining a water outlet state of the swimming pool cleaning robot, and analyzing whether a cause of exiting the water is being manually moved away or accidentally driving away from a water area, leading to a reduction in a misjudgment rate.

### BRIEF DESCRIPTION OF THE DRAWINGS

To more clearly illustrate the technical solutions in the embodiments of the present disclosure or the prior art, the drawings required for describing the embodiments or the prior art will be briefly introduced below. Obviously, the drawings in the following description are only some embodiments of the present disclosure. For those of ordinary skill in the art, other drawings may be obtained based on the structures shown in these drawings without creative efforts.

FIG. 1 is a schematic flowchart of a first embodiment of a swimming pool cleaning robot water outlet detection method of the present disclosure.

FIG. 2 is a schematic structural diagram involved in the swimming pool cleaning robot water outlet detection method of the present disclosure.

FIG. 3 is a schematic flowchart of a second embodiment of the swimming pool cleaning robot water outlet detection method of the present disclosure.

FIG. 4 is a schematic flowchart of a third embodiment of the swimming pool cleaning robot water outlet detection method of the present disclosure.

The realization of the objectives, functional features, and advantages of the present disclosure will be further described in combination with the embodiments and with reference to the drawings.

### DETAILED DESCRIPTION

The technical solutions in the embodiments of the present disclosure will be described clearly and completely below with reference to the accompanying drawings in the embodiments of the present disclosure. It is apparent that the described embodiments are only a part of the embodiments of the present disclosure, and not all of the embodiments. All other embodiments obtained by those of ordinary skill in the art based on the embodiments of the present disclosure without creative efforts fall within the scope of protection of the present disclosure.

Considering that current swimming pool cleaning robots have issues such as misjudgment, missed judgment, or insensitivity in their water outlet detection methods, the present disclosure proposes a solution.

Specifically, the present disclosure proposes a swimming pool cleaning robot water outlet detection method. The technical solution adopted in the present disclosure primarily determines the type of water outlet state a swimming pool cleaning robot is in by using a gyroscope sensor and two sets of water outlet detection probes provided on the swimming pool cleaning robot. The swimming pool cleaning robot is controlled to execute a retreat program to retreat into the water and continue completing remaining work in response to the swimming pool cleaning robot accidentally driving away from a water surface. The swimming pool cleaning robot is controlled to maintain a stopped operation state in response to the swimming pool cleaning robot accidentally stopping operation.

Specifically, a first water outlet detection probe is provided at a top of the swimming pool cleaning robot in the present disclosure, and a second water outlet detection probe is provided at a bottom of the swimming pool cleaning robot. The first water outlet detection probe and the second water outlet detection probe are in a conducting state in response to being under a water surface. The first water outlet detection probe and the second water outlet detection probe are not in the conducting state in response to leaving the water surface.

A gyroscope sensor configured to detect a triaxial attitude angle of the swimming pool cleaning robot is provided in an interior of the swimming pool cleaning robot.

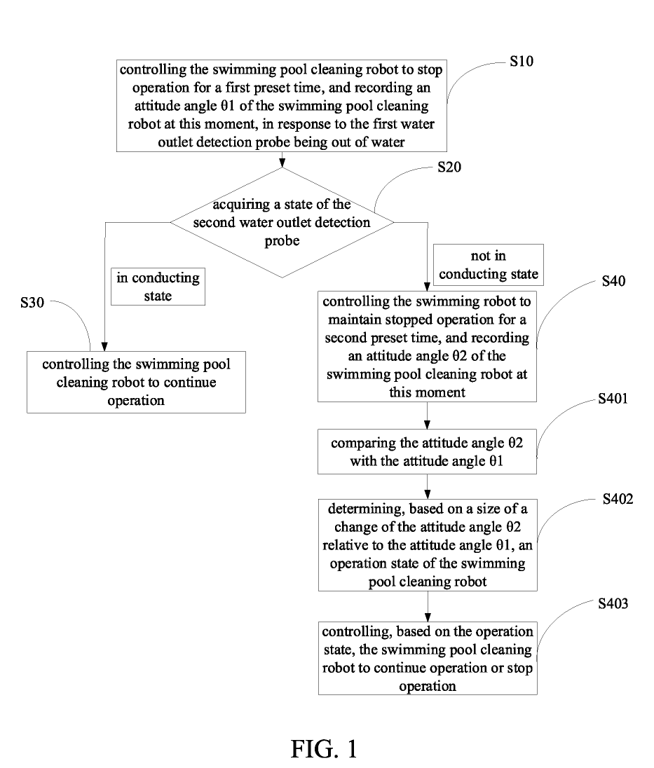

Referring to FIG. 1, a first embodiment of the swimming pool cleaning robot water outlet detection method of the present disclosure includes the following steps:

Step S10: controlling the swimming pool cleaning robot to stop operation for a first preset time and recording an attitude angle θ1 of the swimming pool cleaning robot at this moment in response to the first water outlet detection probe leaving water.

The swimming pool cleaning robot may be accidentally driving away from the water surface or may be accidentally stopping operation in response to the first water outlet detection probe leaving water and not being in the conducting state. Therefore, the swimming pool cleaning robot is controlled to stop operation for the first preset time in response to the first water outlet detection probe leaving water in the present embodiment.

In some implementations, the present embodiment considers that a change size of the attitude angle is significantly different when the swimming pool cleaning robot accidentally drives away from the water surface and when it accidentally stops operation. The attitude angle θ1 of the swimming pool cleaning robot at this moment is recorded to subsequently further accurately determine whether the swimming pool cleaning robot is accidentally driving away from the water surface or accidentally stopping operation. Therefore, the attitude angle θ1 of the swimming pool cleaning robot at this moment is recorded while controlling the swimming pool cleaning robot to stop operation for the first preset time in the present embodiment.

Step S20: acquiring whether the second water outlet detection probe is in the conducting state.

In the present embodiment, it indicates that the second water outlet detection probe is located under the water surface in response to the second water outlet detection probe being in the conducting state. It indicates that the second water outlet detection probe is exposed above the water surface in response to the second water outlet detection probe not being in the conducting state.

Step S30: controlling the swimming pool cleaning robot to continue operation in response to the second water outlet detection probe being in the conducting state.

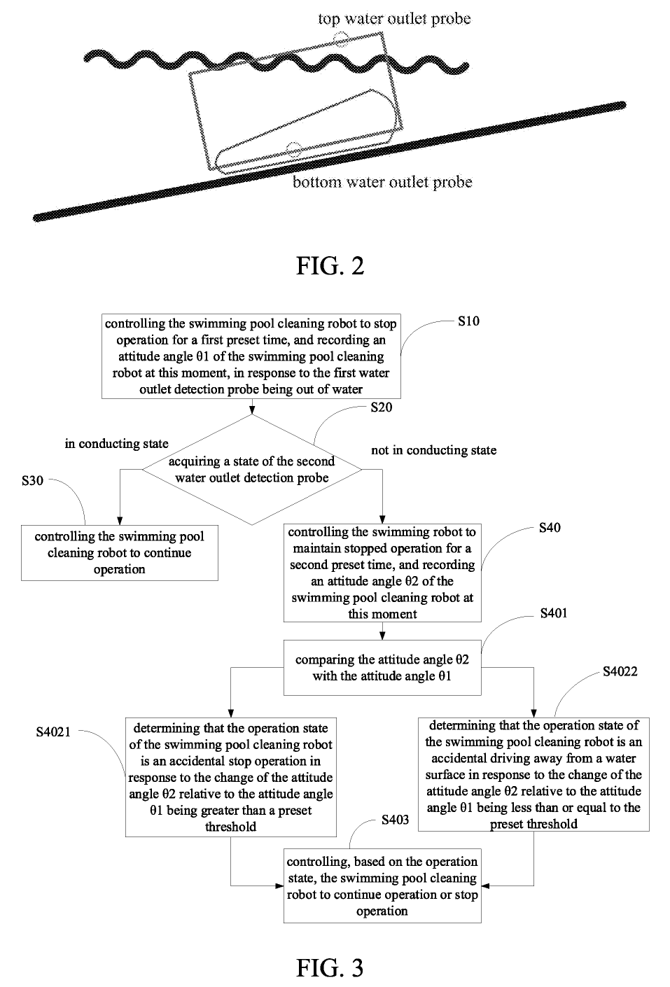

It indicates that the second water outlet detection probe is located under the water surface in response to the second water outlet detection probe being in the conducting state. It may be determined that the swimming pool cleaning robot is accidentally driving away from the water surface in response to the first water outlet detection probe being exposed above the water surface while the second water outlet detection probe is still in the conducting state. As shown in FIG. 2, a situation where the first water outlet detection probe is exposed above the water surface while the second water outlet detection probe is located under the water surface may occur in response to a bottom of the swimming pool being a slope and the swimming pool cleaning robot moving upward along the slope. This moment corresponds to the swimming pool cleaning robot accidentally driving away from the water surface.

Step S40: controlling the swimming pool cleaning robot to maintain stopping operation for a second preset time and recording an attitude angle θ2 of the swimming pool cleaning robot at this moment in response to the second water outlet detection probe not being in the conducting state.

It indicates that the second water outlet detection probe is exposed above the water surface in response to the second water outlet detection probe not being in the conducting state. The swimming pool cleaning robot may be accidentally driving away from the water surface or may be accidentally stopping operation at this moment. Therefore, the swimming pool cleaning robot is controlled to maintain stopping operation for the second preset time and the attitude angle θ2 of the swimming pool cleaning robot at this moment is recorded in response to the second water outlet detection probe not being in the conducting state, to subsequently determine whether the swimming pool cleaning robot is accidentally driving away from the water surface or accidentally stopping operation based on a change size of the attitude angle.

Step S401: comparing the attitude angle θ2 with the attitude angle θ1.

Step S402: determining an operation state of the swimming pool cleaning robot based on a change size of the attitude angle θ2 relative to the attitude angle θ1.

Step S403: controlling the swimming pool cleaning robot to continue operation or stop operation based on the operation state of the swimming pool cleaning robot.

A change size of the attitude angle is significantly different when the swimming pool cleaning robot accidentally drives away from the water surface and when it accidentally stops operation. Therefore, whether the swimming pool cleaning robot is accidentally driving away from the water surface or accidentally stopping operation is determined based on the change size of the attitude angle θ2 relative to the attitude angle θ1 in the present embodiment. For example, it may be determined that the swimming pool cleaning robot is accidentally stopping operation in response to the change of the attitude angle θ2relative to the attitude angle θ1 being significant. It may be determined that the swimming pool cleaning robot is accidentally driving away from the water surface in response to the change of the attitude angle θ2 relative to the attitude angle θ1 being insignificant.

In the present embodiment, through the aforementioned technical solution, the swimming pool cleaning robot is controlled to stop operation for the first preset time and the attitude angle θ1 of the swimming pool cleaning robot at this moment is recorded in response to the first water outlet detection probe leaving water; whether the second water outlet detection probe is in the conducting state is acquired; the swimming pool cleaning robot is controlled to continue operation in response to the second water outlet detection probe being in the conducting state; the swimming pool cleaning robot is controlled to maintain stopping operation for the second preset time and the attitude angle θ2 of the swimming pool cleaning robot at this moment is recorded in response to the second water outlet detection probe not being in the conducting state; the attitude angle θ2 is compared with the attitude angle θ1; the operation state of the swimming pool cleaning robot is determined based on the change size of the attitude angle θ2relative to the attitude angle θ1; the swimming pool cleaning robot is controlled to continue operation or stop operation based on the operation state. The water outlet state of the swimming pool cleaning robot may be accurately determined, the cause of leaving water may be analyzed as being manually removed or accidentally driving away from the water area, and a misjudgment rate is reduced.

As shown in FIG. 3, based on the first embodiment shown in FIG. 1, a second embodiment of the swimming pool cleaning robot water outlet detection method of the present disclosure is proposed.

The difference between this embodiment and the first embodiment shown in FIG. 1 lies in that, in this embodiment, step S402 includes:
step S4021, the operation state of the swimming pool cleaning robot is accidental stop operation in response to a change of the attitude angle θ2 relative to the attitude angle θ1 is greater than a preset threshold;
step S4022, the operation state of the swimming pool cleaning robot is accidental driving away from a water surface in response to the change of the attitude angle θ2 relative to the attitude angle θ1 is less than or equal to the preset threshold.

In the present embodiment, the preset threshold may be set according to actual empirical values. For example, it is set to 15 degrees. That is, the operation state of the swimming pool cleaning robot is determined as accidental stop operation in response to the change of the attitude angle θ2relative to the attitude angle θ1 being greater than 15 degrees, and the operation state of the swimming pool cleaning robot is determined as accidental driving away from a water surface in response to the change of the attitude angle θ2 relative to the attitude angle θ1 being greater than 15 degrees.

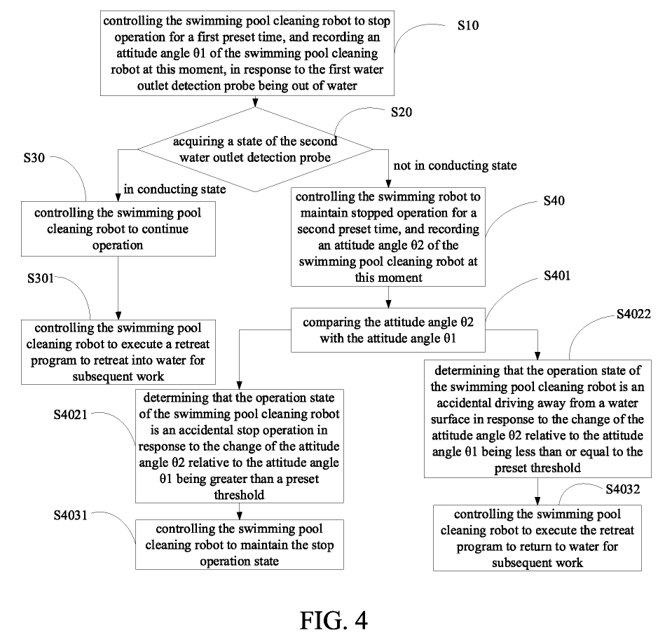

In some implementations, referring to FIG. 4, based on the second embodiment shown in FIG. 3, a third embodiment of the swimming pool cleaning robot water outlet detection method of the present disclosure is proposed, the difference between this embodiment and the second embodiment shown in FIG. 3 lies in that, in the present embodiment, after step S30, the method further includes:
step S301, controlling the swimming pool cleaning robot to execute a retreat program to return to the water for subsequent work.

Step S403 includes:
step S4031, controlling the swimming pool cleaning robot to maintain a stop operation state in response to the operation state of the swimming pool cleaning robot being accidental stop operation.

It should be noted that, in the present embodiment, after controlling the swimming pool cleaning robot to maintain the stop operation state in response to the operation state of the swimming pool cleaning robot being accidental stop operation, the swimming pool cleaning robot may be controlled to execute the retreat program to return to the water for subsequent work in response to the accident being eliminated.

step S4032, controlling the swimming pool cleaning robot to execute the retreat program to return to the water for subsequent work in response to the operation state of the swimming pool cleaning robot being accidental driving away from a water surface.

The beneficial effects of the swimming pool cleaning robot water outlet detection method of the present disclosure are:

The present disclosure, through the above technical solution, controls the swimming pool cleaning robot to stop operating for a first preset time and records the attitude angle θ1 of the swimming pool cleaning robot at this moment in response to the first water outlet detection probe being out of water; determining whether the second water outlet detection probe is in a conducting state; controlling the swimming pool cleaning robot to continue operation in response to the second water outlet detection probe being still in the conducting state; controlling the swimming pool cleaning robot to continue maintaining a stop for a second preset time and recording the attitude angle θ2 of the swimming pool cleaning robot at this moment in response to the second water outlet detection probe being not in the conducting state; comparing the attitude angle θ2 with the attitude angle θ1; determining whether the swimming pool cleaning robot accidentally drove away from the water surface or accidentally stopped operation based on a size of a change of the attitude angle θ2 relative to the attitude angle θ1, which may accurately determine the water outlet state of the swimming pool cleaning robot, analyze whether the water outlet reason is accidental stop operation or accidental driving away from the water surface, leading to a reduced misjudgment rate.

To achieve the above objective, the present disclosure further proposes a swimming pool cleaning robot water outlet detection system, the swimming pool cleaning robot water outlet detection system includes a first water outlet detection probe provided at a top of the swimming pool cleaning robot, a second water outlet detection probe provided at a bottom of the swimming pool cleaning robot, and a gyroscope sensor provided in an interior of the swimming pool cleaning robot, the swimming pool cleaning robot water outlet detection system further includes a memory, a processor, and a swimming pool cleaning robot water outlet detection program stored on the memory, the swimming pool cleaning robot water outlet detection program, when executed by the processor, implements the steps of:
controlling the swimming pool cleaning robot to stop operating for a first preset time and recording an attitude angle θ1 of the swimming pool cleaning robot at this moment in response to the first water outlet detection probe being out of water;
acquiring a conducting state of the second water outlet detection probe;
controlling the swimming pool cleaning robot to continue operation in response to the second water outlet detection probe being in the conducting state;
controlling the swimming pool cleaning robot to maintain a stop for a second preset time and recording an attitude angle θ2 of the swimming pool cleaning robot at this moment in response to the second water outlet detection probe not being in the conducting state;
comparing the attitude angle θ2 with the attitude angle θ1;
determining an operation state of the swimming pool cleaning robot based on a size of a change of the attitude angle θ2 relative to the attitude angle θ1;
controlling the swimming pool cleaning robot to continue operation or stop operation based on the operation state.

In some implementations, the swimming pool cleaning robot water outlet detection program, when executed by the processor, further implements the steps of:
determining that the operation state of the swimming pool cleaning robot is accidental stop operation in response to a change of the attitude angle θ2 relative to the attitude angle θ1 being greater than a preset threshold;
determining that the operation state of the swimming pool cleaning robot is accidental driving away from a water surface in response to the change of the attitude angle θ2 relative to the attitude angle θ1 being less than or equal to the preset threshold.

In some implementations, the step of controlling the swimming pool cleaning robot to continue operation in response to the second water outlet detection probe being in the conducting state further includes the step of:
controlling the swimming pool cleaning robot to execute a retreat program to return to the water for subsequent work.

In some implementations, the step of controlling the swimming pool cleaning robot to continue operation or stop operation based on the operation state further includes the step of:
controlling the swimming pool cleaning robot to maintain a stop operation state in response to the operation state of the swimming pool cleaning robot being accidental stop operation.

The beneficial effects of the swimming pool cleaning robot water outlet detection system of the present disclosure are:

In some implementations, the swimming pool cleaning robot is controlled to stop operation for a first preset time and an attitude angle θ1 of the swimming pool cleaning robot at this moment is recorded in response to the first water outlet detection probe being out of water; determining whether the second water outlet detection probe is in a conducting state; determining that the swimming pool cleaning robot accidentally drives away from a water surface in response to the second water outlet detection probe being still in the conducting state; controlling the swimming pool cleaning robot to continue stopping operation for a second preset time and recording an attitude angle θ2 of the swimming pool cleaning robot at this moment in response to the second water outlet detection probe being not in the conducting state; comparing the attitude angle θ2 with the attitude angle θ1, and determining whether the swimming pool cleaning robot accidentally drives away from the water surface or is manually moved away from the water surface based on a change size of the attitude angle θ2 relative to the attitude angle θ1, thereby accurately determining an out-of-water state of the swimming pool cleaning robot, analyzing whether a water outlet cause is an accidental stop operation or an accidental driving away from a water area, and reducing a misjudgment rate.

To achieve the above objective, the present disclosure further proposes a non-transitory computer-readable storage medium storing a swimming pool cleaning robot water outlet detection program, steps of the method described in the above embodiments being executed in response to the swimming pool cleaning robot water outlet detection program being called by a processor, which is not repeated here.

The above descriptions are only preferred implementations of the present disclosure, and are not intended to limit the scope of patent protection of the present disclosure. Any equivalent structural transformation made under the concept of the present disclosure using the content of the description and the accompanying drawings of the present disclosure, or direct/indirect application in other related technical fields, is included in the scope of patent protection of the present disclosure.

What is claimed is:

1. A swimming pool cleaning robot water outlet detection method, wherein a top of a swimming pool cleaning robot is provided with a first water outlet detection probe, a bottom of the swimming pool cleaning robot is provided with a second water outlet detection probe, an interior of the swimming pool cleaning robot is provided with a gyroscope sensor configured to detect a triaxial attitude angle of the swimming pool cleaning robot, and the swimming pool cleaning robot water outlet detection method comprises the following steps:
step S10, controlling the swimming pool cleaning robot to stop operation for a first preset time, and recording an attitude angle θ1 of the swimming pool cleaning robot at this moment, in response to the first water outlet detection probe being out of water;
step S20, acquiring a state of the second water outlet detection probe;
step S30, controlling the swimming pool cleaning robot to continue operation in response to the second water outlet detection probe being in a conducting state;
step S40, controlling the swimming pool cleaning robot to maintain stopped operation for a second preset time, and recording an attitude angle θ2 of the swimming pool cleaning robot at this moment, in response to the second water outlet detection probe being not in the conducting state;
step S401, comparing the attitude angle θ2 with the attitude angle θ1;
step S402, determining, based on a size of a change of the attitude angle θ2 relative to the attitude angle θ1, an operation state of the swimming pool cleaning robot; and
step S403, controlling, based on the operation state, the swimming pool cleaning robot to continue operation or stop operation.

2. The swimming pool cleaning robot water outlet detection method according to claim 1, wherein the determining, based on the size of the change of the attitude angle θ2 relative to the attitude angle θ1, the operation state of the swimming pool cleaning robot comprises:
step S4021, determining that the operation state of the swimming pool cleaning robot is an accidental stop operation in response to the change of the attitude angle θ2 relative to the attitude angle θ1 being greater than a preset threshold; and
step S4022, determining that the operation state of the swimming pool cleaning robot is an accidental driving away from a water surface in response to the change of the attitude angle θ2 relative to the attitude angle θ1 being less than or equal to the preset threshold.

3. The swimming pool cleaning robot water outlet detection method according to claim 2, wherein the method further comprises, subsequent to the step S30:
step S301, controlling the swimming pool cleaning robot to execute a retreat program to retreat into water for subsequent work.

4. The swimming pool cleaning robot water outlet detection method according to claim 2, wherein the step S403 comprises:
step S4031, controlling the swimming pool cleaning robot to maintain a stop operation state in response to the operation state of the swimming pool cleaning robot being the accidental stop operation.

5. The swimming pool cleaning robot water outlet detection method according to claim 2, wherein the step S403 comprises:
step S4032, controlling the swimming pool cleaning robot to execute the retreat program to return to water for subsequent work in response to the operation state of the swimming pool cleaning robot being the accidental driving away from the water surface.

6. A swimming pool cleaning robot water outlet detection system, wherein the system comprises a first water outlet detection probe provided at a top of a swimming pool cleaning robot, a second water outlet detection probe provided at a bottom of the swimming pool cleaning robot, and a gyroscope sensor provided in an interior of the swimming pool cleaning robot, the system further comprises a memory, a processor, and a swimming pool cleaning robot water outlet detection program stored on the processor, the swimming pool cleaning robot water outlet detection program, when executed by the processor, performs the following steps:
controlling the swimming pool cleaning robot to stop operation for a first preset time, and recording an attitude angle θ1 of the swimming pool cleaning robot at this moment, in response to the first water outlet detection probe being out of water;
acquiring a conducting state of the second water outlet detection probe;
controlling the swimming pool cleaning robot to continue operation in response to the second water outlet detection probe being in the conducting state;
controlling the swimming pool cleaning robot to maintain stopped operation for a second preset time, and recording an attitude angle θ2 of the swimming pool cleaning robot at this moment, in response to the second water outlet detection probe being not in the conducting state;
comparing the attitude angle θ2with the attitude angle θ1;
determining, based on a size of a change of the attitude angle θ2 relative to the attitude angle θ1, an operation state of the swimming pool cleaning robot;
controlling, based on the operation state, the swimming pool cleaning robot to continue operation or stop operation.

7. The swimming pool cleaning robot water outlet detection system according to claim 6, wherein the swimming pool cleaning robot water outlet detection program, when executed by the processor, further performs the following steps:
determining that the operation state of the swimming pool cleaning robot is an accidental stop operation in response to the change of the attitude angle θ2 relative to the attitude angle θ1 being greater than a preset threshold;
determining that the operation state of the swimming pool cleaning robot is an accidental driving away from a water surface in response to the change of the attitude angle θ2relative to the attitude angle θ1 being less than or equal to the preset threshold.

8. The swimming pool cleaning robot water outlet detection system according to claim 6, wherein the program, subsequent to the step of controlling the swimming pool cleaning robot to continue operation in response to the second water outlet detection probe being in the conducting state, performs the following steps:
controlling the swimming pool cleaning robot to execute a retreat program to retreat into water for subsequent work.

9. The swimming pool cleaning robot water outlet detection system according to claim 7, wherein the step of controlling, based on the operation state, the swimming pool cleaning robot to continue operation or stop operation further comprises:
controlling the swimming pool cleaning robot to maintain a stop operation state in response to the operation state of the swimming pool cleaning robot being the accidental stop operation.

10. A non-transitory computer-readable storage medium, wherein the non-transitory computer-readable storage medium stores a swimming pool cleaning robot water outlet detection program, the swimming pool cleaning robot water outlet detection program, when invoked by a processor, performs the following steps:
step S10, controlling a swimming pool cleaning robot to stop operation for a first preset time, and recording an attitude angle θ1 of the swimming pool cleaning robot at this moment, in response to a first water outlet detection probe being out of water;
step S20, acquiring a state of a second water outlet detection probe;
step S30, controlling the swimming pool cleaning robot to continue operation in response to the second water outlet detection probe being in a conducting state;
step S40, controlling the swimming pool cleaning robot to remain stopped for a second preset time and recording an attitude angle θ2 of the swimming pool cleaning robot at this moment in response to the second water outlet detection probe being not in the conducting state;
step S401, comparing the attitude angle θ2 with the attitude angle θ1;
step S402, determining an operating state of the swimming pool cleaning robot based on a size of a change of the attitude angle θ2 relative to the attitude angle θ1;
step S403, controlling the swimming pool cleaning robot to continue operation or stop operation based on the operating state; the determining the operating state of the swimming pool cleaning robot based on the size of the change of the attitude angle θ2relative to the attitude angle θ1 comprises:
step S4021, determining that the operating state of the swimming pool cleaning robot is an accidental stop operation in response to the change of the attitude angle θ2 relative to the attitude angle θ1 being greater than a preset threshold;
step S4022, determining that the operating state of the swimming pool cleaning robot is an accidental drive away from a water surface in response to the change of the attitude angle θ2relative to the attitude angle θ1 being less than or equal to the preset threshold.
